(19) United States
(12) Patent Application Publication
(10) Pub. No.: US 2004/0089982 A1
(43) Pub. Date: May 13, 2004

(54) Ice cream scoop and method of use

(76) Inventor: Michael Witthoft, Kowloon (CN)

Correspondence Address: Kenneth F. Florek, Hedman & Costigan, P.C., 1185 Avenue of the Americas, New York, NY, 10036-2646, US

(21) Appl. No.: 10/290,606

(22) Filed: Nov. 8, 2002

(51) Int. Cl. A23G 9/28

(52) U.S. Cl. 264/334; 425/282; 425/281

(57) ABSTRACT

An ice cream scoop for removing frozen to semi-frozen desserts from a container comprising a scoop portion and a handle portion. The scoop portion comprises a rim portion and a deformable portion, the deformable portion having a resilient, flexible and/or elastomeric material that allows for easy removal of frozen to semi-frozen desserts from the scoop by physically pressing on the exterior of the deformable portion. A method of use of this scoop includes scooping the dessert, inverting the scoop portion over the area desired and depressing the deformable portion to release the dessert from the scoop.

### BACKGROUND OF THE INVENTION

Several methods and devices exist in the field of kitchenware and commercial dessert sales for the removal of frozen to semi-frozen desserts from a container. The initial function of the prior art devices is to remove a hard frozen to semi-frozen dessert without bending the scoop, or other such device to be used, and to limit the strain on the operator of the ice cream scoop. Another function of at least some of such devices is to provide an easy and quick method of removing the frozen dessert product from the scoop. In this regard, difficulty in removal of the frozen food product is caused by the adhesion of the cold ice cream to most materials used in the manufacturing of ice cream scoops.

Examples of prior art devices directed to the removal and release of frozen dessert products, generally termed ice cream scoops, can be found in U.S. Pat. No. 772,674; U.S. Pat. No. 4,721,449; U.S. Pat. No. 4,699,582; U.S. Pat. No. 2,756,698; and U.S. Pat. No. 4,392,806.

The prior art in this area contains numerous inventions that use combinations of mechanical contraptions and heating devices to scoop a frozen dessert product from its container and subsequently remove the frozen dessert product from the scoop. The drawbacks to these inventions are the myriad number of moving parts to break and/or malfunction and difficulty of use. This creates a need for constant repairs, replacement parts, additional production costs and consumer angst.

The present invention solves the problems associated with the prior art by eliminating moving parts and the need for heating the device, thereby reducing costs and adding to ease of use.

### SUMMARY OF THE INVENTION

The present invention is directed to an ice-cream scoop comprising a scoop portion and a handle portion, said scoop portion comprising a rim portion and a deformable portion below said rim portion which allows for easy removal of desserts from a frozen to semi-frozen container.

The ice cream scoop is used by scooping the frozen to semi-frozen desert from a container, inverting the scoop over an area in which the scoop is to be placed and depressing the deformable portion of the scoop.

The deformable portion preferably comprises a resilient flexible material placed in at least an area of the hemispherically shaped hollow scoop of said ice cream scoop. It allows the operator to press the ice cream out of the scoop by applying pressure with one of the operator's fingers, in so doing overcoming the adhesive forces and releasing the frozen dessert from the scoop.

The present invention preferably includes additional adaptations increasing its ease of use and functionality. For example, the rim of the scoop itself is formed at an angle to create a cutting edge that assists in separating the hard ice cream being scooped out from its container. This reduces tension on the operator's arm and increases speed and efficiency of use of the claimed device.

Also, the most preferred embodiment includes an opening in the end of the handle opposite the scoop, for easy storage by hanging on a hook or other kitchenware storage system.

### BRIEF DESCRIPTION OF THE DRAWINGS

FIG. 1 is a cross sectional side elevation of the preferred scoop of the present invention.

FIG. 2 is a plan view of the preferred scoop of the present invention.

### DESCRIPTION OF THE PREFERRED EMBODIMENT

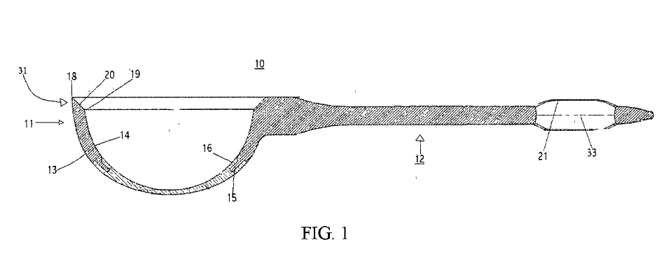

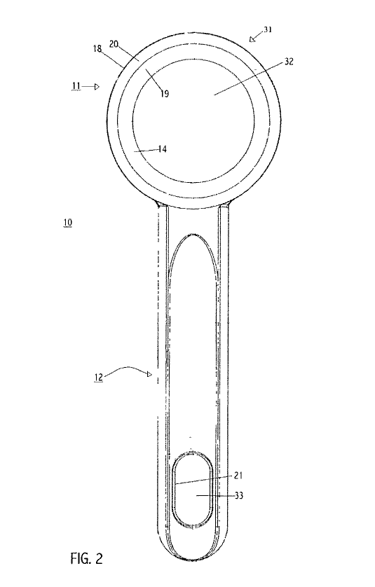

Referring to FIGS. 1 and 2, the ice cream scoop (10) of the present invention comprises a scoop portion (11) and a handle portion (12). The scoop portion (11) is preferably a hemispherically shaped hollow scoop having a rigid rim portion (31) and a deformable portion (32) in an area below said rim portion (31).

In its preferred embodiment the rigid rim portion (31) is formed from a hard plastic, most preferably LEXAN®, through methods commonly known in the art. The rim portion (31) comprises an upper exterior edge (18), an exterior scoop wall (13) and an interior scoop wall (14).

Most preferably, the leading edge of the rim portion (31) comes to an end point at the upper exterior edge (18) with the interior scoop wall (14) coming to an end point at an upper interior edge (19). The area (20) between the exterior and interior edges (18 and 19) is preferably angled downwardly and inwardly into the scoop so as to form a cutting surface at the upper exterior edge (18).

The lower end of rim portion (31) preferably terminates in a centrally located opening defined by exterior scoop wall (13) and interior scoop wall (14), preferably in the form a tongue (15), to cooperate in the engagement of the deformable portion (32). The bottom of the scoop portion (11) comprises a deformable portion (32), preferably formed of a resilient, flexible, elastomeric material. The upper end of the deformable portion (32) preferably comprises a groove (16), which cooperates with said tongue (15) of said rim portion (31), to permanently join the rim portion (31) and the deformable portion (32).

Although any suitable material can be used, in its most preferred embodiment the resilient, flexible, elastomeric material of the deformable portion (32) is SANTOPRENE®. The deformable portion (32) and rigid rim portion (31) are permanently joined using techniques commonly known in the art, including adhesives, heat welding and the like.

Extending from the hemispherically shaped hollow scoop portion (11), preferably along a diameter perpendicular from the central axis of said scoop portion (11), is a handle portion (12). The handle portion (12) is preferably formed of the same material as the rim portion (31) of said scoop portion (11). Most preferably the handle is integrally formed with the rigid rim portion (31) of said scoop portion (11).

An opening (33) is preferably formed in the end of said handle (12), opposite the end which is coupled to the scoop portion (11), for hanging the ice cream scoop (10). Most preferably, the opening (33) comprises an interior handle wall (21), which runs in a continuous oval type shape defining the handle opening (33).

During use, a user grasps the ice cream scoop (10) by the handle portion (12) and pushes the scoop portion (11) through a frozen to semi-frozen dessert using a scooping motion. The scoop portion (11), full of the frozen to semi-frozen dessert, is inverted over an area where the dessert is to be placed. The user presses against the deformable portion (32) of the scoop portion (11) to physically push the frozen dessert from the scoop portion (11).

Variations, modifications and alterations to the above detailed description will be apparent to those skilled in the art in reviewing the present specification. All such variations, and modifications and alternatives are intended to fall within the scope of the present invention, limited only by the appended claims. All cited patents are incorporated by reference.

I claim:

1. An ice cream scoop comprising a scoop portion and a handle portion, said scoop portion comprising a rim portion and a deformable portion.

2. The ice cream scoop of claim 1, wherein said handle portion and said rim portion of said scoop portion are integrally formed.

3. The ice cream scoop of claim 2, wherein said scoop portion and said handle portion are made of a rigid material.

4. The ice cream scoop of claim 3, wherein said rigid material is plastic.

5. The ice cream scoop of claim 4, wherein said plastic is LEXAN®.

6. The ice cream scoop of claim 1, wherein said deformable portion is a resilient, flexible and/or elastomeric material.

7. The ice cream scoop of claim 1, wherein said deformable portion is formed of SANTOPRENE®.

8. The ice cream scoop of claim 6, wherein said deformable portion is formed of SANTOPRENE®.

9. The ice cream scoop of claim 1, wherein said rim portion includes a leading edge comprising an angled portion between an exterior wall and an interior wall to create a cutting surface.

10. The ice cream scoop of claim 1, wherein said handle portion further comprises an opening in the end of said handle portion opposite said scoop portion.

11. A method for scooping a frozen to semi-frozen dessert from a container comprising the steps of scooping the frozen to semi-frozen dessert with an ice cream scoop having a scoop portion including a deformable portion, thereon, inverting the scoop portion over an area in which the frozen to semi-frozen dessert is to be placed and depressing the deformable portion of the scoop to release said frozen to semi-frozen dessert from said scoop.

12. The method of claim 11 wherein the deformable portion depressed is formed of a resilient, flexible and/or elastomeric material.
